(19) United States
(12) Patent Application Publication
(10) Pub. No.: US 2026/0350027 A1
(43) Pub. Date: Nov. 5, 2026

(54) SYSTEM AND METHOD OF PROVIDING TIME-TRAVELING VISUALIZATION ON LARGE DATASETS

(71) Applicant: Hugging Face, Inc., Brooklyn, NY (US)

(72) Inventors: Allison WHILDEN, Redmond, WA (US); Shyengjun HUANG, Seattle, WA (US); Zachary NATION, Seattle, WA (US); Yucheng LOW, Seattle, WA (US)

(21) Appl. No.: 19/197,409

(22) Filed: May 2, 2025

Related U.S. Application Data
(60) Provisional application No. 63/561,175, filed on Mar. 4, 2024.

(51) Int. Cl. G06F 16/248

(52) U.S. Cl. CPC G06F 16/248

(57) ABSTRACT

A device may include at least one memory. A device may at least one processor coupled to the at least one memory and configured to: obtain a plurality of snapshots in a dataset, generate a first summary of a first snapshot in the plurality of snapshots, generate a second summary based on the first summary and a change between the first snapshot in the plurality of snapshots and a second snapshot of the plurality of snapshots; and present a visual comparison between the first summary and the second summary. The device may also generate a data package to submit to an artificial intelligence model for analysis of changes from snapshot to snapshot.

### PRIORITY CLAIM

The present application claims priority to U.S. Provisional Patent Application No. 63/561,175, field on Mar. 4, 2024, the contents of which are incorporated herein by reference.

### FIELD OF THE DISCLOSURE

Aspects of the present disclosure generally relate to large datasets and more specifically to new systems and methods of allowing interactive time traveling visualizations on massive datasets. The approach enables improved visualization of how large datasets evolve over time.

### BACKGROUND

A dataset can include collections of one or more tables, unstructured data such as text and images, or machine learning (ML) models. Datasets can change over time as new data is collected, data is cleaned, and new models are trained. Due to the size of such datasets, it can be difficult to determine how the data is changing over time and how the quality of the data or models has shifted.

### SUMMARY

The disclosed approach addresses the issues of visualizing large datasets that change over time. The approach generally includes a new way of generating respective summaries of respective snapshots of the dataset. The dataset can relate to any type of dataset such as images, videos, audio, tables, machine learning models (of any type), text or any kind of data. The disclosed approach provides a new way of generating summaries of snapshots of the dataset and then generating snapshot deltas or differences between snapshots and using that difference to generate summary updates. The approach can then include visualization of the differences in the snapshots and/or the differences in the summaries of the snapshots with new ways of interacting with the visualization. The approach improved the ability of humans to be able to understand and visualize changes in the dataset over time in more efficient ways.

In some aspects, the techniques described herein relate to an apparatus for providing time traveling visualization on large datasets, including: at least one memory; and at least one processor coupled to the at least one memory and configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; and present a visual comparison between the first summary and the second summary.

In some aspects, the techniques described herein relate to a method for providing time traveling visualization on large datasets, the method including: obtaining a plurality of snapshots in a dataset; generating a first summary of a first snapshot in the plurality of snapshots; generating a second summary based on the first summary and a change between the first snapshot in the plurality of snapshots and a second snapshot of the plurality of snapshots; and presenting a visual comparison between the first summary and the second summary.

In some aspects, the techniques described herein relate to a computer-readable storage medium storing instructions which, when executed by at least one processor coupled to the computer-readable storage medium cause the at least one processor to be configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; and present a visual comparison between the first summary and the second summary.

In some aspects, the techniques described herein relate to a method including: obtaining a plurality of snapshots in a dataset; generating a first summary of a first snapshot in the plurality of snapshots; generating a second summary based on the first summary and a change between the first snapshot in the plurality of snapshots and a second snapshot of the plurality of snapshots; generating a data package with the first summary, the second summary and instructions for a machine learning model to perform an analysis; transmitting the data package to a machine learning model; and receiving a response from the machine learning model, the response including an analysis of the first summary and the second summary according to the instructions.

In some aspects, the techniques described herein relate to an apparatus for providing time traveling visualization on large datasets, including: at least one memory; and at least one processor coupled to the at least one memory and configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; generate a data package with the first summary, the second summary and instructions for a machine learning model to perform an analysis; transmit the data package to a machine learning model; and receive a response from the machine learning model, the response including an analysis of the first summary and the second summary according to the instructions.

In some aspects, the techniques described herein relate to a computer-readable storage medium storing instructions which, when executed by at least one processor coupled to the computer-readable storage medium cause the at least one processor to be configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; generate a data package with the first summary, the second summary and instructions for a machine learning model to perform an analysis; transmit the data package to a machine learning model; and receive a response from the machine learning model, the response including an analysis of the first summary and the second summary according to the instructions.

Aspects generally include a method, apparatus, system, computer program product, non-transitory computer-readable medium, user equipment, network node, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram showing some of the components typically incorporated in at least some of the computer systems and other devices on which the disclosed system operates in accordance with some implementations of the present technology;

FIG. 2 is a system diagram illustrating an example of a computing environment in which the disclosed system operates in some implementations of the present technology, in accordance with some aspects of this disclosure;

FIG. 3 illustrates a snapshot summarization, in accordance with some aspects of this disclosure;

FIG. 4 illustrates a way to generate summary updates, in accordance with some aspects of this disclosure;

FIG. 5 illustrates a side-by-side comparison of a first and second snapshot using a visualization of the summaries of the first and second snapshot, in accordance with some aspects of this disclosure;

FIG. 6 illustrates a comparison of snapshots and an image comparison, in accordance with some aspects of this disclosure;

FIG. 7 illustrates an accuracy metric over time for a machine learning model, in accordance with some aspects of this disclosure;

FIG. 8 illustrates an artificial intelligence-powered comparison of two snapshots, in accordance with some aspects of this disclosure;

FIG. 9 illustrates an image cluster comparison, in accordance with some aspects of this disclosure;

FIG. 10 is a diagram illustrating an example method for providing time-traveling visualization on large datasets, in accordance with some examples.

FIG. 11 is a diagram illustrating an example method for generating a data package for a machine learning model to analyze changes in summaries of datasets over time, in accordance with some examples.

The drawings have not necessarily been drawn to scale. For example, some components and/or operations may be separated into different blocks or combined into a single block for the purposes of discussion of some of the embodiments of the disclosed system. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents and alternatives falling within the scope of the technology as defined by the appended claims.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Time-evolving data is a common trend in industry, but management of such data is a significant challenge. In machine learning (ML) model use cases, such as recommendation systems for a storefront, interaction data is collected (i.e., who clicked on an item, who purchased an item, how did the person navigate the website). As events in the world occur and different people interact with the website, the data distribution may change over time due to viral trends, marketing campaigns or other seasonal trends. For example, the items people buy during winter or at a holiday season are different relative to items bought during the summer.

As trends from, for example, five years ago may not be useful for predicting today's demands, old data is frequently evicted or pruned and a sliding window snapshot of training data is frequently used. The approach disclosed herein can help to understand in a more efficient way changes to datasets using summaries generated and made available for visualization purposes.

In some cases, models such as OpenAI or Grok artificial intelligence (AI) models will process data from the internet or other sources for training and answer detailed and complicated questions. The models can also receive data to analyse. In some cases, factual information may be incorrect. For example, initial news sources about an event may be incorrect and later updated and corrected. Competing news may present difficulty in obtaining the underlying facts of an event for analysis by an AI model. Thus, snapshots of the world of knowledge available for such AI models can be dynamically changing. Existing methods to manage, monitor, and understand these historical snapshots are poor. In some aspects, such snapshots are typically simply stored as separate folders in a blobstore (i.e., such as Amazon's S3 storage facility). As a result, it can be difficult to understand how the data is evolving over time. For instance, how is the data distribution changing over time? Questions arise such as, what are the most popular items? It can be difficult to determine how many people never made purchases from a website. It can be difficult to understand how the quality of the ML models has changed over time.

In business intelligence (BI) use cases, analysts can create dashboards which provide exploration and visualization of business metrics. These dashboards evolve over time with the needs of the business, and for audit purposes, it can be beneficial to maintain a verifiable history of the dashboards created. Furthermore, the source data for the dashboards may also change (for instance, a particular dashboard may be connected to a live database) and it can be advantageous to snapshot the source data to allow the dashboards to be reproduced correctly.

In the BI scenario, it can be advantageous to understand how and when the dashboards have changed. For instance, side-by-side visualization of dashboards can make it easier to make comparisons. An example question is: how has a particular chart changed between last month and this month? As another example, the way a certain metric (e.g., a user engagement metric) is computed may have changed over time, and it can be advantageous to know which historical charts are meaningfully comparable. Additionally, the schemas of certain database tables may have changed, leading to incorrect dashboards. Time-traveling visualizations allow the user to easily debug and identify a particular (e.g., earliest) point in time the dashboards were inaccurate, allowing for more reliable business decisions.

An example challenge with visualizations is that the source data for visualizations can be large. For instance, a snapshot of a database table could be represented by 10 GB of data. However, because of storing a daily (or other periodic) snapshot, a year of snapshot data would require over 3.6 TB. While compression and other data deduplication methods can significantly reduce the storage requirements, performing visualization on such data can still mean that 3.6 TB should be read and processed. In some cases, it is also useful for visualizations to be interactive, and the scale of the data processing makes this challenging. Accordingly, disclosed herein is a solution that allows for interactive time-travelling visualizations on large datasets.

With respect to formally defining a dataset, one could take an un-opinionated perspective on data, allowing for both structured and unstructured forms. More generally, a dataset can be defined as a collection of files. Such files can comprise of collections of tables (for instance, Parquet files), unstructured data such as text, audio, images, video, and/or ML models.

The following systems and methods are disclosed to address the issues in the art raised above. In some aspects, the techniques described herein relate to an apparatus for providing time traveling visualization on large datasets, including: at least one memory; and at least one processor coupled to the at least one memory and configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; and present a visual comparison between the first summary and the second summary. The type of data in the datasets or the types of files in the dataset can vary as described herein.

In some aspects, the techniques described herein relate to a method for providing time traveling visualization on large datasets, the method including: obtaining a plurality of snapshots in a dataset; generating a first summary of a first snapshot in the plurality of snapshots; generating a second summary based on the first summary and a change between the first snapshot in the plurality of snapshots and a second snapshot of the plurality of snapshots; and presenting a visual comparison between the first summary and the second summary.

In general, the approach disclosed herein utilizes snapshots of a dataset or datasets. Snapshots of datasets can be performed on a regular basis: for instance, once a day a database could be exported to a Parquet table. As another example, a developer can manually take a snapshot of a dashboarding application and the data the dashboard uses. Data associated with machine learning models can be obtained periodically as s snapshot of values in the models, error values for the model from a known truth, outputs from the model, or data related to training data for the machine learning models.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

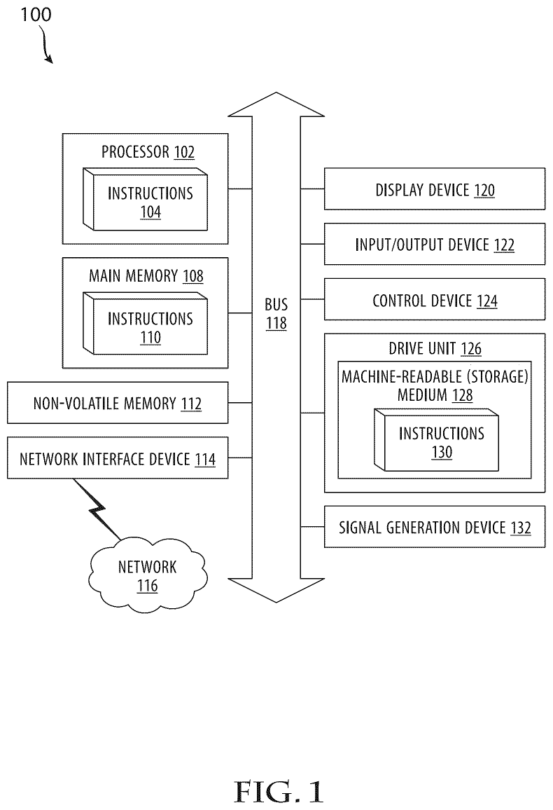

FIG. 1 is a block diagram showing some of the components typically incorporated in at least some of the computer systems and other devices on which the disclosed system operates in accordance with some implementations of the present technology. FIG. 1 illustrates a computer system 100 on which the disclosed system can operates in accordance with some implementations of the present technology. As shown, the computer system 100 can include: one or more processors 102, a main memory 108, a non-volatile memory 110, a network interface device 114, a video display device 120, an input/output device 122, a control device 124 (e.g., keyboard, mouse, and/or pointing device), a drive unit 126 that includes a machine-readable medium 128, and a signal generation device 132 that are communicatively connected to a bus 118. The bus 118 represents one or more physical buses and/or point-to-point connections that are connected by appropriate bridges, adapters, or controllers. Various common components (e.g., cache memory) are omitted from FIG. 1 for brevity. Instead, the computer system 100 is intended to illustrate a hardware device on which components illustrated or described relative to the examples of the figures and any other components described in this specification can be implemented.

The one or more processor 102 can include first instructions 104 which are stored for causing the one or more processor 102 to perform certain operations or functions. The main memory 108 can store second instructions 110 which can be used by the one or more processor 102 or any other component for a carrying out instructions or operations. The machine-readable medium 128 can store third instructions 130 for guiding or controlling the drive unit 126. Any of the computer-readable mediums disclosed can be non-transitory storage devices to distinguish them from the air interface through which transitory electromagnetic signals (configured to contain data) can travel.

The computer system 100 can take any suitable physical form. For example, the computer system 100 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 100. In some implementations, the computer system 100 can be an embedded computer system, a system-on-chip (SOC), a single-board computer system (SBC) or a distributed system such as a mesh of computer systems or include one or more cloud components in one or more networks. Where appropriate, one or more computer systems can perform operations in real-time, near real-time, or in batch mode.

The network interface device 114 enables the computer system 100 to exchange data in a network 116 with an entity that is external to the computing system 100 through any communication protocol supported by the computer system 100 and the external entity. Examples of the network interface device 114 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 108, non-volatile memory 112, machine-readable medium 128) can be local, remote, or distributed. Although shown as a single medium, the machine-readable medium 128 can include multiple media (e.g., a centralized/distributed database and/or associated caches and servers) that store one or more sets of instructions 130. The machine-readable (storage) medium 128 can include any medium that is capable of storing, encoding, or carrying a set of instructions for execution by the computer system 100. The machine-readable medium 128 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., first instructions 104, second instructions 110, and third instructions 130) set at various times in various memory and storage devices in computing device(s). When read and executed by the one or more processor 102, the instruction(s) cause the computer system 100 to perform operations to execute elements involving the various aspects of the disclosure.

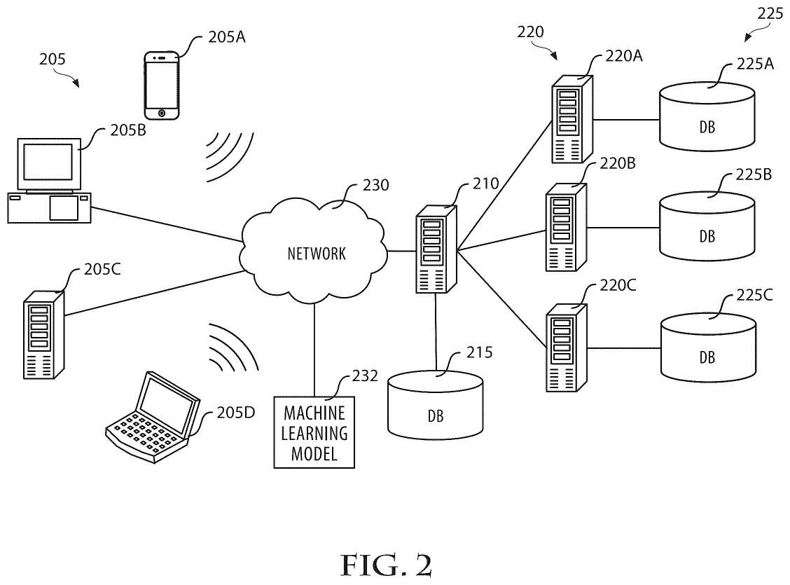

FIG. 2 is a system diagram showing a compute environment 200 illustrating an example of a computing environment in which the disclosed system operates in some implementations of the present technology, in accordance with some aspects of this disclosure.

In some implementations, the compute environment 200 includes one or more client computing devices such as a first client computing device 205A, a second client computing device 205B, a third client computing device 205C, and a fourth client computing device 205D (collectively, client computing devices 205), examples of which can host the computing system 100. Client computing devices 205 operate in a networked environment using logical connections through network 230, such as the Internet, to one or more remote computers, such as a server computing device.

In some implementations, a server 210 can be an edge server which receives client requests and coordinates fulfillment of those requests through other servers, such as a first server 220A, a second server 220B, and a third server 220C (collectively servers 220). In some implementations, the server 210 and servers 220 can include computing systems, such as the computing system 100. Though each server 210 and servers 220 is displayed logically as a single server, server computing devices can each be a distributed computing environment encompassing multiple computing devices located at the same or at geographically disparate physical locations. In some implementations, each of the servers 220 can correspond to a group of servers.

In some aspects, the servers 220 can represent also a blockchain network which stores a distributed ledger instances and distributed consensus algorithms that operate to store such data as dataset snapshots on the distributed ledger instances when the distributed consensus algorithm makes a proper determination that a particular snapshot is accurate and should be recorded on the blockchain. The blockchain could also record summaries or other representations of the dataset rather than the full snapshot of the dataset. The benefit of using a blockchain network can be the immutability of the storage of the summaries or snapshots or any other associated data to confirm that the data has not been altered. In this regard, the summaries may be stored in the blockchain network over time and then retrieved and processed as disclosed herein in a manner that can be trusted relative to normal or traditional storage techniques.

Client computing devices 205 and the server 210 and servers 220 can each act as a server or client to other server or client devices. In some implementations, the server 210 and or the servers 220 connect to a database 215, a first database 225A, a second database 225B, a third database 225C (collectively databases 225). As discussed above, the servers 220 can correspond to a group of servers, and each of these servers can share a database or can have its own database. The database 215 and the databases 225 can store information. Though the database 215 and databases 225 are displayed logically as single units, the database 215 and the databases 225 can each be a distributed computing environment encompassing multiple computing devices, can be located within their corresponding server, or can be located at the same or at geographically disparate physical locations. As noted above, the servers 220 can represent a blockchain network and the databases 225 can represent the hardware used to store respective distributed ledger instances that each record in a block of the blockchain data associated with this disclosure.

The network 230 can be the Internet, a local area network (LAN) or a wide area network (WAN), but can also be other wired or wireless networks of nay protocol such as 5G, WiFi, Bluetooth and so forth. In some implementations, the network 230 is the Internet or some other public or private network. Client computing devices 205 are connected to network 230 through a network interface, such as by wired or wireless communication. While the connections between the server 210 and the servers 220 are shown as separate connections, these connections can be any kind of local, wide area, wired, or wireless network, including network 230 or a separate public or private network.

A machine learning model 232 can be used also to receive a data package related to the summaries of multiple snapshots of a dataset over time. The data package can include instructions and summaries (in various forms) to provide an artificial intelligence analysis over time of the various summaries and to provide feedback, such as a summary of the changes to the summaries (and thus the snapshots) over time.

Part of this disclosure can include processes occurring or being performed on any one or more of the disclosure computing components in these figures. For example, some processes might be performed on one of the client computing devices 205, one of the servers 220, the server 210 and/or the machine learning model 232. Where some processes might be described with respect to one computing device, also disclosed in this application are complementary processes that might be performed by other components. As a specific example, one disclosed embodiment may relate to method practiced by the server 210 which includes generating a data package which can include summaries, snapshots and instructions for the machine learning model 232 to analyze the data package and provide a report. The method may include transmitting the data package to the machine learning model 232 and receiving the report. Also disclosed can be a method performed by the machine learning model 232 which can include receiving the data package and performing the analysis on the received data as guided by the included instructions in the data package. The machine learning model 232 can the transmit the report to the server 210 (or any other computing device) as part of the complementary process being performed on the machine learning model 232.

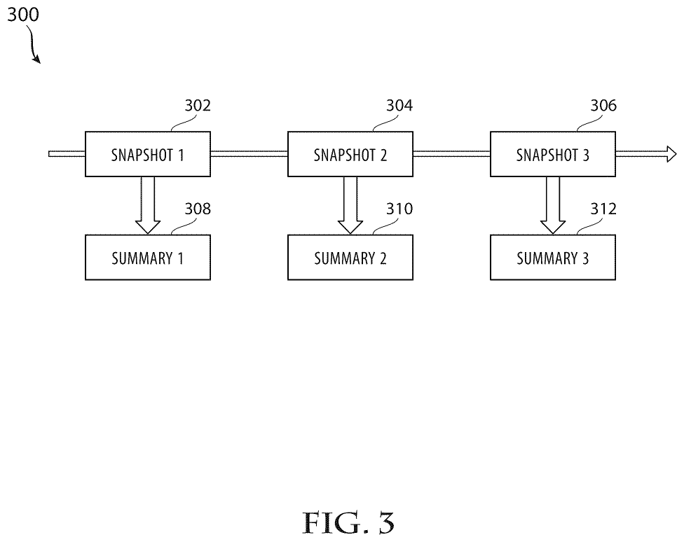

FIG. 3 illustrates a snapshot summarization 300, in accordance with some aspects of this disclosure. As described above, directly comparing snapshots can be impractical due to the typical size and scale of the datasets involved. Disclosed herein is a solution where, for a particular snapshot, one could compute a compact summary on the dataset. A system can generate a first summary 308 from a first snapshot 302. A second snapshot 304 can be used by the system to generate a second summary 310. Similarly, the system can generate a third summary 312 from a third snapshot 306. The approach to generating the summary computations can be customized in which a user can provide user input regarding how these summaries are to be computed.

For tabular data, an example summary can comprise statistical information (columnar summaries such as mean, variance, histogram, distribution), data samples, graphs, and/or charts. For images, videos, and/or audio, the summary can include metadata such as size, colors, an image embedding, location where image was taken, etc. For dashboards, the summary may include a schema, a preview rendering, visual data, colors, shapes, text, other images, etc.

The present disclosure contemplates provisioning of built-in (but customizable) summarization methods for datatypes such as images and tables. Furthermore, various implementations enable the user to provide a user-defined summarization method for datatypes and/or for other metrics of interest. A user interface can be presented on a computing device which can include menus, selectable objects, and so forth to enable a user to customize the summarization methods according to various factors such as a type of the snapshot, or a type of summary and so forth.

The resulting summary can be significantly smaller than the size of the snapshot. The summary can be stored efficiently in a variety of suitable datastores or on a blockchain network as described above.

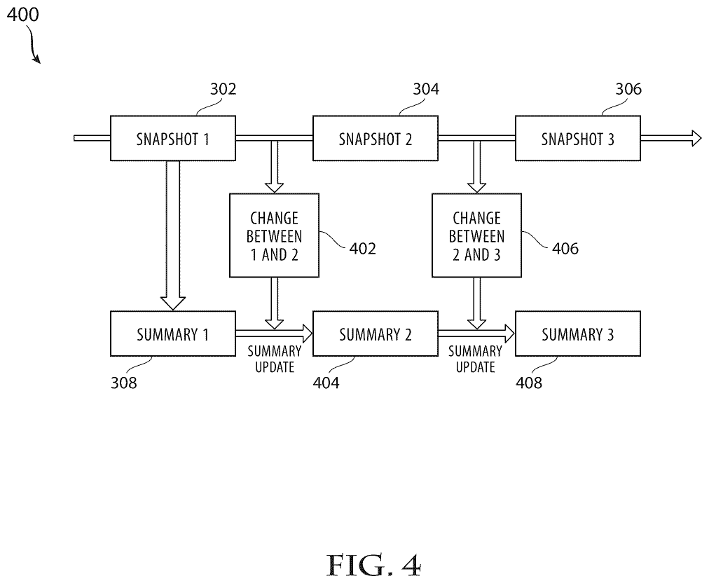

FIG. 4 illustrates a graphical image demonstrating the generation of summary updates 400, in accordance with some aspects of this disclosure. In certain circumstances, a particular storage system can efficiently describe what changed between two snapshots. For instance, when storing a collection of images, it is possible to know what images were added or removed by inspecting a file listing. Alternatively, if a text file changes are stored as differences, it is possible to determine what rows were inserted or removed from a CSV (comma-separated values) file. In such example scenarios, it can be more efficient to update a summary rather than to recompute a summary.

Accordingly, this disclosure contemplates a summary update procedure which can take the previous summary, as well as the change between snapshots, to produce a new summary. For example, the first snapshot 302 is used to generate the first summary 308. The second snapshot 304 can be used to generate the second summary 310 but that can be computationally complicated. In FIG. 4, a first change 402 between the first snapshot 302 and the second snapshot 304 can be used by a computing system 100, along with the first summary 308, to generate a first summary update 404 (or a new second summary). Similarly, a second change 406 between the second snapshot 304 and the third snapshot 306 can be used to generate, from the first summary update 404, a second summary update 408 (or a new third summary).

Such a procedure may not be generally applicable to all summaries. For instance, while statistics such as mean and/or variance can be updated with insertions and deletions, statistics such as “maximum value” can be difficult to update with data deletions. If the row containing the maximum value was removed, one may scan the dataset to find the new largest value. Certain approximate sketch data structures may be used for summary statistics, but many such sketch data structures may not provide for data removal.

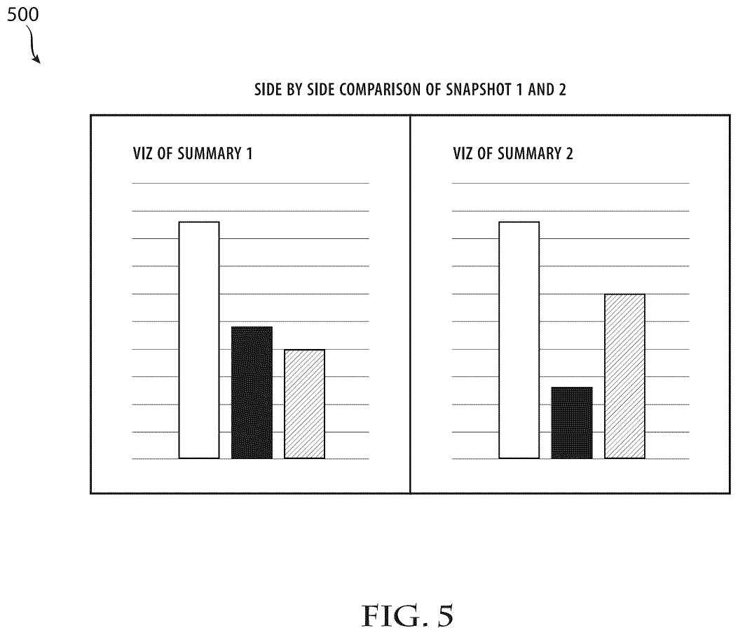

FIG. 5 illustrates a first graph 500 illustrating a side-by-side comparison of the first snapshot 302 and the second snapshot 304 using a visualization of the summaries of the first and second snapshot, in accordance with some aspects of this disclosure. The snapshots created according to the methods contemplated herein can be visually compared by providing side-by-side visualizations of the data summaries. Note that what is shown in FIG. 5 is the visualization of either the first summary 308 and the second summary 310 or it can be the first summary 308 and the first summary update 404 of FIG. 4.

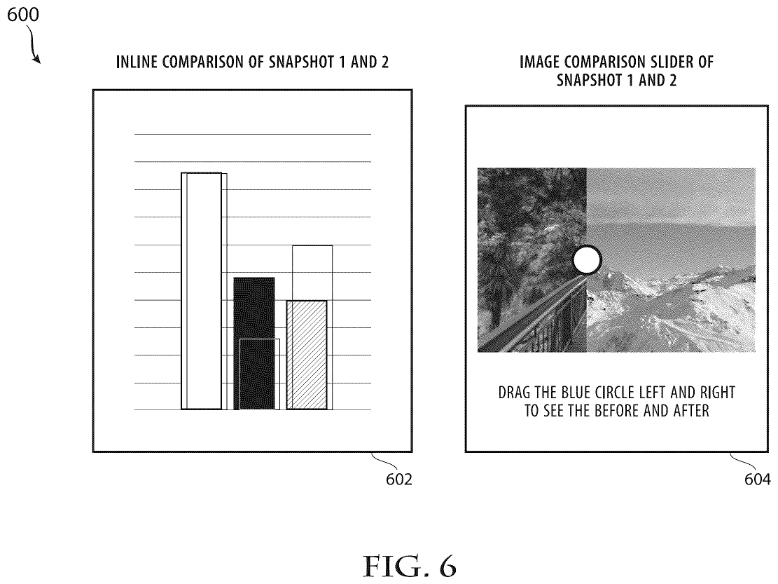

Other forms of inline comparisons can help to visually distinguish what has changed between two snapshots. FIG. 6 illustrates a comparison 600 of snapshots 602 and an image comparison 604, in accordance with some aspects of this disclosure. Alternatively, summaries can be integrated across time over numerous snapshots. For instance, consider a set of snapshots that contains an ML model and the summary contains statistical information about the model's accuracy. In such cases, one can plot how the model accuracy has changed over all time, combining information across all historical snapshots. The image comparison 604 also can represent a user interface configured to enable a user to drag an object such as a circle by way of example left and right to see the “before and after” of the different snapshots of data.

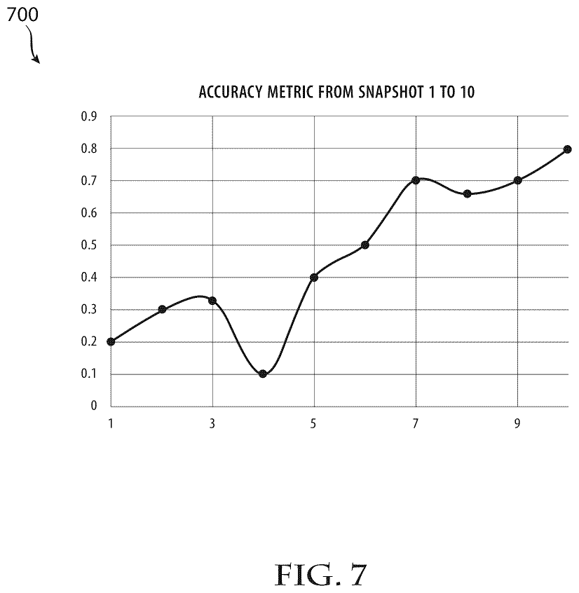

FIG. 7 illustrates a second graph 700 of an accuracy metric over time for a machine learning model, in accordance with some aspects of this disclosure. Using the example plot in the second graph 700, one can determine that model accuracy has been improving over time, but something unusual occurred during a snapshot 4 and may be worth an investigation. This disclosure also contemplates the use of a machine learning model such as a multi-modal large language model or other model also to summarize how data may have changed from snapshot to snapshot. In this regard, the approach can include generating the summaries and update summaries as disclosed herein and then providing a portion or all of the summaries as input to a machine learning model with instructions to review the data and summarize how the data has changed over time or from snapshot to snapshot or according to some other criteria as instructed by the user.

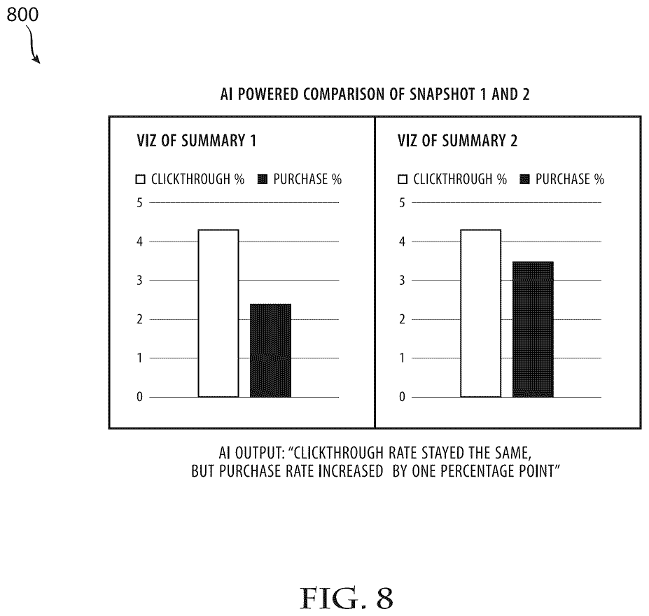

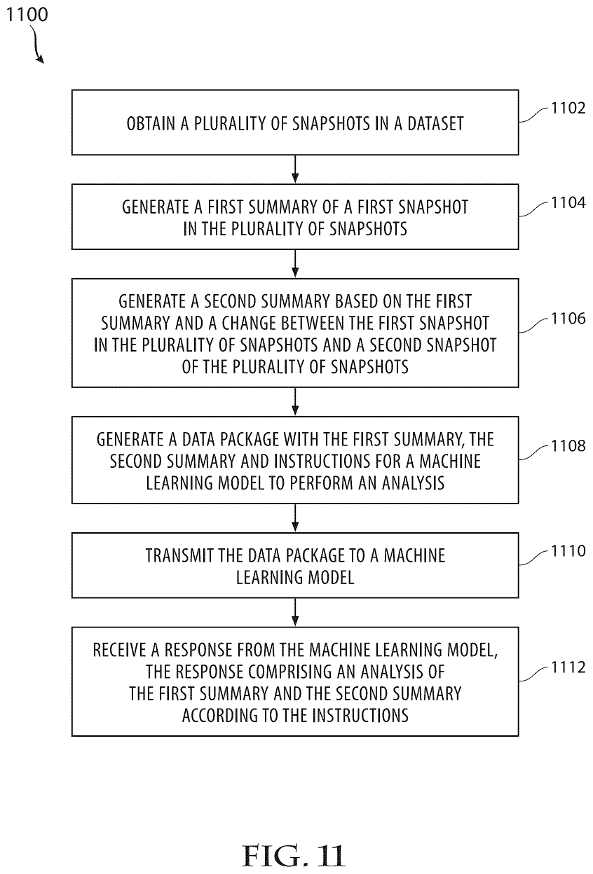

FIG. 8 illustrates an artificial intelligence-powered comparison 800 of two snapshots, in accordance with some aspects of this disclosure. This approach can utilize the machine learning model 232 of FIG. 2. In this case, the dataset related to an analysis of user interactions with a merchant website or interactions related to how users clicked on an advertisement to transition to the merchant website but then did or did not make a purchase. In this case, data associated with the user interactions of multiple users over time and other data can be provided to the machine learning model 232 in a data package with instructions regarding how to analyze and report on the data. A computing device such as the server 210 can generate the date package, transmit it to the machine learning model 232 and receive the report. FIG. 11 illustrates an example method related to generating the data package to submit to the machine learning model 232 which can include data summaries or visualizations of data summaries with instructions to analyze the input and provide a summary of the visualizations of the snapshots.

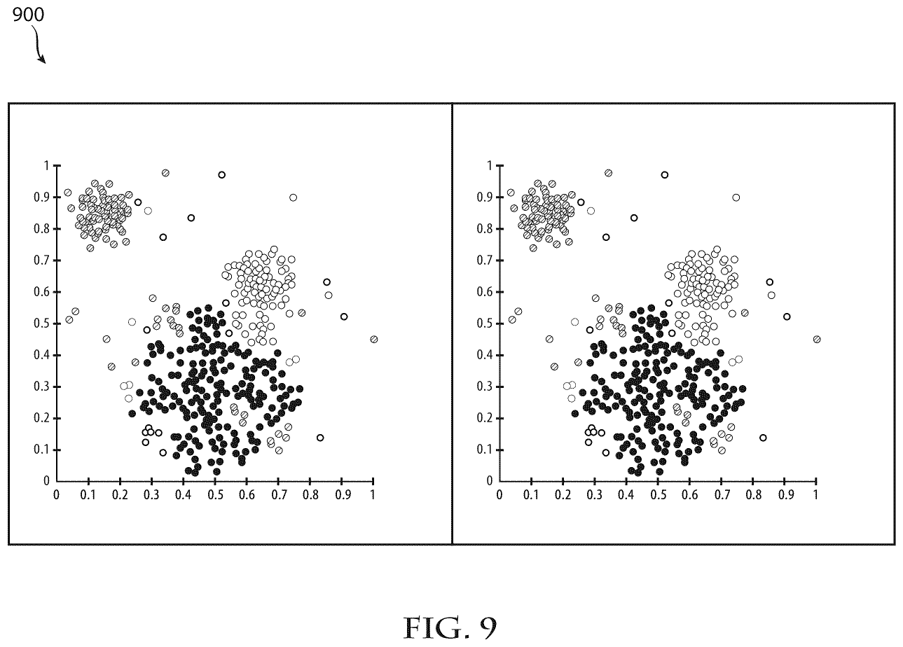

FIG. 9 illustrates a third graph 900 of an image cluster comparison, in accordance with some aspects of this disclosure. In some implementations, users can provide custom ways to compare two summaries, which enables the users to build visualizations that users are interested in. For instance, for image datasets, a user may be interested in clustering images by visual similarity, or semantic (e.g., content of images) similarity, and visualizing how the clusters have changed over time.

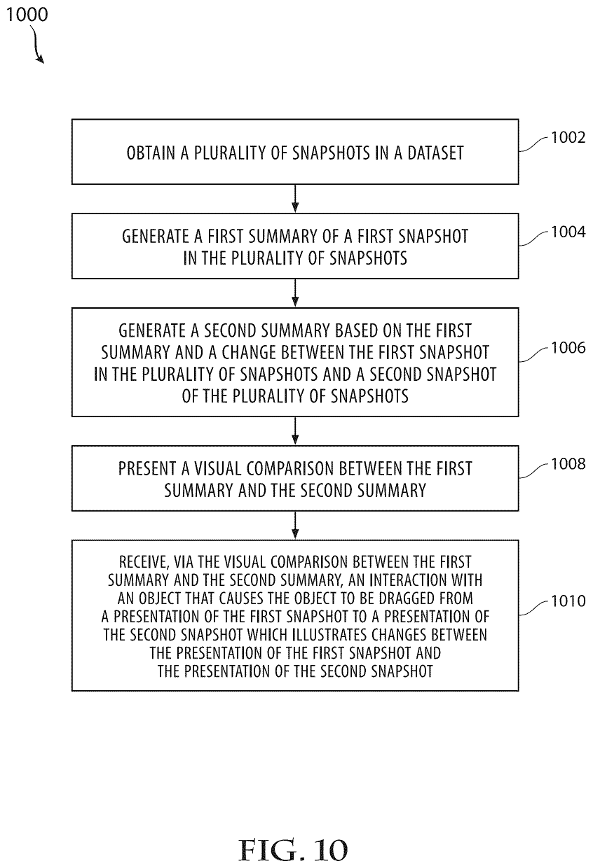

FIG. 10 is a diagram illustrating an example method 1000 for providing time-traveling visualization on large datasets, in accordance with some examples. The example method 1000 can be implemented by a computing system 100, any component in the computing environment 200 and/or subcomponent thereof.

At block 1002, the example method 1000 can be implemented by the computing system (i.e., the computing system 100, any component in the computing environment 200 and/or subcomponent thereof) which can be and is configured to obtain a plurality of snapshots in a dataset. The dataset can include one or more of images, tables, machine learning models, text, alphanumeric data, dashboard data, comma-separated values files, spreadsheets, audios and/or videos.

At block 1004 the example method 1000 can be implemented by the computing system (i.e., the computing system 100, any component in the computing environment 200 and/or subcomponent thereof) which can be and is configured to generate a first summary 308 of a first snapshot 302 in the plurality of snapshots.

At block 1006, the example method 1000 can be implemented by the computing system (i.e., the computing system 100, any component in the computing environment 200 and/or subcomponent thereof) which can be and is configured to generate a second summary (i.e., the first summary update 404) based on the first summary 308 and a change (i.e., the first change 402) between the first snapshot 302 in the plurality of snapshots and a second snapshot 304 of the plurality of snapshots. In some aspects, the first summary and the second summary can include one or more of statistical information, data samples, graphs, charts, metadata, a schema and/or a preview rendering.

In some aspects, the metadata can include one more of a size associated with data in the dataset, a color associated with the data in the dataset, an image embedding, a location associated with an image, an audio file or a video.

In some aspects, generating the first summary and the second summary is based on a user-defined summarization method. The user-defined method can vary depending on the type of data in the datasets, the type of summary desired, a time frame associated with updates (i.e., every minute, every week, etc.), a type of visualization, and so forth.

At block 1008, the example method 1000 can be implemented by the computing system (i.e., the computing system 100, any component in the computing environment 200 and/or subcomponent thereof) which can be and is configured to present a visual comparison between the first summary and the second summary. The visual comparison can include an inline comparison of the first snapshot.

At block 1010, the example method 1000 can be implemented by the computing system (i.e., the computing system 100, any component in the computing environment 200 and/or subcomponent thereof) which can be and is configured to receive, via the visual comparison between the first summary and the second summary, an interaction with an object that causes the object to be dragged from a presentation of the first snapshot to a presentation of the second snapshot which illustrates changes between the presentation of the first snapshot and the presentation of the second snapshot. This can be an optional step in the example method 1000. The dataset can include multiple snapshots of versions of a machine learning model over time. For example, a respective snapshot can be for a respective version of a machine learning model over time.

In some aspects, the visual comparison can include a graph illustrating an accuracy metric over time reflecting the multiple snapshots of versions of the machine learning model over time. The dataset can include multiple snapshots of data related to historical user interactions with website or apps.

In some aspects, the computing system 100 can include an apparatus for providing time traveling visualization on large datasets. The apparatus can include at least one memory; and at least one processor coupled to the at least one memory and configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; and present a visual comparison between the first summary and the second summary.

In some aspects, a computer-readable storage medium can store instructions which, when executed by at least one processor coupled to the computer-readable storage medium cause the at least one processor to be configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; and present a visual comparison between the first summary and the second summary.

FIG. 11 is a diagram illustrating an example method 1100 for providing time-traveling visualization on large datasets, in accordance with some examples. The example method 1100 can be implemented by a computing system 100, any component in the computing environment 200 or subcomponent thereof.

At block 1102, the example method 1100 can be implemented by the computing system (i.e., the computing system 100, any component in the computing environment 200 and/or subcomponent thereof) which can be and is configured to obtain a plurality of snapshots in a dataset.

At block 1104, the example method 1100 can be implemented by the computing system (i.e., the computing system 100, any component in the computing environment 200 and/or subcomponent thereof) which can be and is configured to generate a first summary of a first snapshot in the plurality of snapshots.

At block 1106, the example method 1100 can be implemented by the computing system (i.e., the computing system 100, any component in the computing environment 200 and/or subcomponent thereof) which can be and is configured to generate a second summary based on the first summary and a change between the first snapshot in the plurality of snapshots and a second snapshot of the plurality of snapshots.

At block 1108, the example method 1100 can be implemented by the computing system (i.e., the computing system 100, any component in the computing environment 200 and/or subcomponent thereof) which can be and is configured to generate a data package with the first summary, the second summary and instructions for a machine learning model to perform an analysis.

At block 1110, the example method 1100 can be implemented by the computing system (i.e., the computing system 100, any component in the computing environment 200 and/or subcomponent thereof) which can be and is configured to transmit the data package to a machine learning model.

At block 1112, the example method 1100 can be implemented by the computing system (i.e., the computing system 100, any component in the computing environment 200 and/or subcomponent thereof) which can be and is configured to receive a response from the machine learning model, the response comprising an analysis of the first summary and the second summary according to the instructions.

The method 1100 can apply to a plurality of summaries generated in which each respective summary is associated with a respective snapshot of the plurality of snapshots. For example, a snapshot may be obtained every day, every week or every hour (or any other periodic or aperiodic time frame). The visual comparison may represent a second visual comparison of the plurality of summaries. In some aspects, the snapshots may relate to a state or condition of a machine learning model, or a snapshot of data representing user interactions with a website or application, such that every day there is a snapshot of data of user interactions over that time frame. The approach can include obtaining the respective summaries and then utilizing the summaries to provide a visual representation for better human understanding of the change in the datasets over time. Further, the summaries can be used by a machine learning model for providing the summaries and for querying and obtaining information about the changes in the data over time as analyzed by a machine learning model.

In some aspects, an apparatus for providing time traveling visualization on large datasets. The apparatus can include at least one memory; and at least one processor coupled to the at least one memory and configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; generate a data package with the first summary, the second summary and instructions for a machine learning model to perform an analysis; transmit the data package to a machine learning model; and receive a response from the machine learning model, the response comprising an analysis of the first summary and the second summary according to the instructions.

In some aspects, a computer-readable storage medium stores instructions which, when executed by at least one processor coupled to the computer-readable storage medium cause the at least one processor to be configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; generate a data package with the first summary, the second summary and instructions for a machine learning model to perform an analysis; transmit the data package to a machine learning model; and receive a response from the machine learning model, the response comprising an analysis of the first summary and the second summary according to the instructions.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, engines, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, then the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

Illustrative aspects of the disclosure include: The following provides an overview of some Aspects or Clauses of the present disclosure:
Clause 1. An apparatus for providing time traveling visualization on large datasets, comprising: at least one memory; and at least one processor coupled to the at least one memory and configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; and present a visual comparison between the first summary and the second summary.
Clause 2. The apparatus of clause 1, wherein the at least one processor coupled to the at least one memory and configured to generate the first summary and the second summary based on a user-defined summarization method.
Clause 3. The apparatus of clause 1, wherein the dataset comprises one or more of images, tables, machine learning models, text, alphanumeric data, dashboard data, comma-separated values files, spreadsheets, audios and/or videos.
Clause 4. The apparatus of clause 1, wherein the first summary and the second summary comprise one or more of statistical information, data samples, graphs, charts, metadata, a schema and/or a preview rendering.
Clause 5. The apparatus of clause 4, wherein the metadata comprises one more of a size associated with data in the dataset, a color associated with the data in the dataset, an image embedding, a location associated with an image, an audio file or a video.
Clause 6. The apparatus of clause 1, wherein the visual comparison comprises an inline comparison of the first snapshot.
Clause 7. The apparatus of clause 1, wherein the at least one processor coupled to the at least one memory and configured to: receive, via the visual comparison between the first summary and the second summary, an interaction with an object that causes the object to be dragged from a presentation of the first snapshot to a presentation of the second snapshot which illustrates changes between the presentation of the first snapshot and the presentation of the second snapshot.
Clause 8. The apparatus of clause 1, wherein the dataset comprises multiple snapshots of versions of a machine learning model over time and wherein the visual comparison comprises a graph illustrating an accuracy metric over time reflecting the multiple snapshots of versions of the machine learning model over time.
Clause 9. The apparatus of clause 1, wherein the dataset comprises multiple snapshots of data related to historical user interactions with website or apps.
Clause 10. A method for providing time traveling visualization on large datasets, the method comprising: obtaining a plurality of snapshots in a dataset; generating a first summary of a first snapshot in the plurality of snapshots; generating a second summary based on the first summary and a change between the first snapshot in the plurality of snapshots and a second snapshot of the plurality of snapshots; and presenting a visual comparison between the first summary and the second summary.
Clause 11. The method of clause 10, wherein generating the first summary and the second summary is based on a user-defined summarization method.
Clause 12. The method of clause 10, wherein the dataset comprises one or more of images, tables, machine learning models, text, alphanumeric data, dashboard data, comma-separated values files, spreadsheets, audios and/or videos.
Clause 13. The method of clause 10, wherein the first summary and the second summary comprise one or more of statistical information, data samples, graphs, charts, metadata, a schema and/or a preview rendering.
Clause 14. The method of clause 13, wherein the metadata comprises one more of a size associated with data in the dataset, a color associated with the data in the dataset, an image embedding, a location associated with an image, an audio file or a video.
Clause 15. The method of clause 10, wherein the visual comparison comprises an inline comparison of the first snapshot.
Clause 16. The method of clause 10, further comprising: receiving, via the visual comparison between the first summary and the second summary, an interaction with an object that causes the object to be dragged from a presentation of the first snapshot to a presentation of the second snapshot which illustrates changes between the presentation of the first snapshot and the presentation of the second snapshot.
Clause 17. The method of clause 10, wherein the dataset comprises multiple snapshots of versions of a machine learning model over time.
Clause 18. The method of clause 17, wherein the visual comparison comprises a graph illustrating an accuracy metric over time reflecting the multiple snapshots of versions of the machine learning model over time.
Clause 19. The method of clause 10, wherein the dataset comprises multiple snapshots of data related to historical user interactions with website or apps.
Clause 20. The method of clause 10, wherein the method applies to a plurality of summaries generated in which each respective summary is associated with a respective snapshot of the plurality of snapshots and wherein the visual comparison comprises a second visual comparison of the plurality of summaries.
Clause 21. A computer-readable storage medium storing instructions which, when executed by at least one processor coupled to the computer-readable storage medium cause the at least one processor to be configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; and present a visual comparison between the first summary and the second summary.
Clause 22. A method comprising: obtaining a plurality of snapshots in a dataset; generating a first summary of a first snapshot in the plurality of snapshots; generating a second summary based on the first summary and a change between the first snapshot in the plurality of snapshots and a second snapshot of the plurality of snapshots; generating a data package with the first summary, the second summary and instructions for a machine learning model to perform an analysis; transmitting the data package to a machine learning model; and receiving a response from the machine learning model, the response comprising an analysis of the first summary and the second summary according to the instructions.
Clause 23. An apparatus for providing time traveling visualization on large datasets, comprising: at least one memory; and at least one processor coupled to the at least one memory and configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; generate a data package with the first summary, the second summary and instructions for a machine learning model to perform an analysis; transmit the data package to a machine learning model; and receive a response from the machine learning model, the response comprising an analysis of the first summary and the second summary according to the instructions.
Clause 24. A computer-readable storage medium storing instructions which, when executed by at least one processor coupled to the computer-readable storage medium cause the at least one processor to be configured to: obtain a plurality of snapshots in a dataset; generate a first summary of a first snapshot in the plurality of snapshots; generate a second summary based on the first summary and a change between the first snapshot in the plurality of snapshots and a second snapshot of the plurality of snapshots; generate a data package with the first summary, the second summary and instructions for a machine learning model to perform an analysis; transmit the data package to a machine learning model; and receive a response from the machine learning model, the response comprising an analysis of the first summary and the second summary according to the instructions.

1. An apparatus for providing time traveling visualization on large datasets, comprising:
at least one memory; and
at least one processor coupled to the at least one memory and configured to:
obtain a plurality of snapshots in a dataset;
generate a first summary of a first snapshot in the plurality of snapshots;
generate a second summary based on the first summary and a change between the first snapshot in the plurality of snapshots and a second snapshot of the plurality of snapshots; and
present a visual comparison between the first summary and the second summary.

2. The apparatus of claim 1, wherein the at least one processor coupled to the at least one memory and configured to generate the first summary and the second summary based on a user-defined summarization method.

3. The apparatus of claim 1, wherein the dataset comprises one or more of images, tables, machine learning models, text, alphanumeric data, dashboard data, comma-separated values files, spreadsheets, audios and/or videos.

4. The apparatus of claim 1, wherein the first summary and the second summary comprise one or more of statistical information, data samples, graphs, charts, metadata, a schema and/or a preview rendering.

5. The apparatus of claim 4, wherein the metadata comprises one more of a size associated with data in the dataset, a color associated with the data in the dataset, an image embedding, a location associated with an image, an audio file or a video.

6. The apparatus of claim 1, wherein the apparatus is configured to process a plurality of summaries generated in which each respective summary is associated with a respective snapshot of the plurality of snapshots and wherein the visual comparison comprises a second visual comparison of the plurality of summaries.

7. The apparatus of claim 1, wherein the at least one processor coupled to the at least one memory and configured to:
receive, via the visual comparison between the first summary and the second summary, an interaction with an object that causes the object to be dragged from a presentation of the first snapshot to a presentation of the second snapshot which illustrates changes between the presentation of the first snapshot and the presentation of the second snapshot.

8. The apparatus of claim 1, wherein the dataset comprises multiple snapshots of versions of a machine learning model over time and wherein the visual comparison comprises a graph illustrating an accuracy metric over time reflecting the multiple snapshots of versions of the machine learning model over time.

9. The apparatus of claim 1, wherein the dataset comprises multiple snapshots of data related to historical user interactions with website or apps.

10. A method for providing time traveling visualization on large datasets, the method comprising:
obtaining a plurality of snapshots in a dataset;
generating a first summary of a first snapshot in the plurality of snapshots;
generating a second summary based on the first summary and a change between the first snapshot in the plurality of snapshots and a second snapshot of the plurality of snapshots; and
presenting a visual comparison between the first summary and the second summary.

11. The method of claim 10, wherein generating the first summary and the second summary is based on a user-defined summarization method.

12. The method of claim 10, wherein the dataset comprises one or more of images, tables, machine learning models, text, alphanumeric data, dashboard data, comma-separated values files, spreadsheets, audios and/or videos.

13. The method of claim 10, wherein the first summary and the second summary comprise one or more of statistical information, data samples, graphs, charts, metadata, a schema and/or a preview rendering.

14. The method of claim 13, wherein the metadata comprises one more of a size associated with data in the dataset, a color associated with the data in the dataset, an image embedding, a location associated with an image, an audio file or a video.

15. The method of claim 10, wherein the visual comparison comprises an inline comparison of the first snapshot.

16. The method of claim 10, further comprising:
receiving, via the visual comparison between the first summary and the second summary, an interaction with an object that causes the object to be dragged from a presentation of the first snapshot to a presentation of the second snapshot which illustrates changes between the presentation of the first snapshot and the presentation of the second snapshot.

17. The method of claim 10, wherein the dataset comprises multiple snapshots of versions of a machine learning model over time.

18. The method of claim 17, wherein the visual comparison comprises a graph illustrating an accuracy metric over time reflecting the multiple snapshots of versions of the machine learning model over time.

19. The method of claim 10, wherein the dataset comprises multiple snapshots of data related to historical user interactions with website or apps.

20. The method of claim 10, wherein the method applies to a plurality of summaries generated in which each respective summary is associated with a respective snapshot of the plurality of snapshots and wherein the visual comparison comprises a second visual comparison of the plurality of summaries.

21. A non-transitory computer-readable storage medium storing instructions which, when executed by at least one processor coupled to the computer-readable storage medium cause the at least one processor to be configured to:
obtain a plurality of snapshots in a dataset;
generate a first summary of a first snapshot in the plurality of snapshots;
generate a second summary based on the first summary and a change between the first snapshot in the plurality of snapshots and a second snapshot of the plurality of snapshots; and
present a visual comparison between the first summary and the second summary.
